(19) United States
(12) Patent Application Publication
(10) Pub. No.: US 2002/0156540 A1
(43) Pub. Date: Oct. 24, 2002

(54) Tool for automatic testability analysis

(76) Inventors: Florence Akli, Les Clayes Sous Bois (FR); Alain Debreil, Plaisir (FR); Christian Niquet, Bourg-La-Reine (FR)

Correspondence Address: Miles & Stockbridge, Suite 500, 1751 Pinnacle Drive, McLean, VA, 22102-3833, US

(21) Appl. No.: 10/049,023

(22) PCT Filed: Jun. 7, 2001
(86) PCT No.: PCT/FR01/01764

(30) Foreign Application Priority Data
Jun. 8, 2000 (FR) 00/07354

(51) Int. Cl. G05B 11/01

(52) U.S. Cl. 700/12; 700/27; 700/13

(57) ABSTRACT

In order to test whether a given signal of a complex circuit has the correct behavior, the method makes it possible to obtain in a computer memory a profile of states of other signals for which a state of the given signal is expected in a physical sample of the circuit. In order to minimize the processing time and the memory space required to obtain this profile, the method uses binary decision diagrams. Since the given signal can have more than two states (B, H, Z), the method generates at least two binary decision diagrams, a first binary decision diagram wherein the value at 1 indicates that the signal is in the first or in the second state, and a second binary decision diagram wherein the value at 1 indicates that the signal is in the second or in the third state.

The field of application of the invention is that of tools for automatic testability analysis tools and for automatic generation of tests of complex logical circuits.

In an integrated circuit manufacturing process, a design phase, generally computer-aided, generates a connection list (netlist). A net list contains the elements of the circuit such as the transistors and input-output connectors, and the links between these elements, such as traces for conveying signals from one element to another.

The netlist makes it possible to generate a mask that is used to etch the circuit into a semiconductor material in order to produce wafers, each constituting a physical sample of the circuit.

Before encapsulating a wafer in a printed circuit package, it is important to verify that this physical sample is free of defects, i.e., that each signal generated by this sample is actually the same as provided for by the netlist.

In order to sort the good samples from the bad, each sample is tested by applying electrical state stimuli to certain signals of the sample, and by observing whether the resulting electrical states of the signals match those provided for in the design phase of the circuit.

Test vectors, each representing a set of stimuli, are determined by means of a computer that processes in memory the netlist of the circuit. Given the complexity of current integrated circuits, an exhaustive processing of the netlist by means of truth tables would require memory sizes and calculation times incompatible with production constraints in terms of time and cost.

It is already known from the prior art to use binary decision diagrams to reduce the memory size and the calculation time required for logical analysis of a circuit in design phases. This is the case, for example, in the U.S. Pat. Nos. 5,434,794, 5,737,242 and 5,905,977 in the field of verification and formal proof.

Let us recall that a binary decision diagram T_{f}, associated with a first boolean function f(a, b, c, . . . , w) of binary variables a, b, c, . . . w is accessible by means of a first computer data structure that makes it possible to represent in memory the values assumed by the first function f, based on the values assumed by the binary variables a, b, c, . . . w. This first data structure is constructed using the known properties of a Shannon decomposition relative to a first variable a, i.e., using the usual notations for writing logical functions:

f(a,b,c, . . . , w)=\overline{a}·f(a=0,b,c, . . . , w)+a·f(a=1,b,c, . . . , w)

where f(a=0, b, c, . . . , w) is a second invariable boolean function based on a, since a is set at zero, and where f(a=1, b, c, . . . , w) is a third invariable boolean function based on a since a is set at one. The second boolean function assumes the same values as the first boolean function based on the values assumed by the binary variables b, c, . . . , w when a=0. The third boolean function assumes the same values as the first boolean function based on the values assumed by the binary variables b, c, . . . , w when a=1. The first data structure therefore appears as a triplet of addresses of storage areas {a, f(a=0, b, . . . ), f(a=1, b, . . . )}, which therefore comprises a first node occupied by the first variable a, a left pointer to a second data structure {b, f(a=0, b=0, . . . ), f(a=0, b=1, . . . )} that makes it possible to access a first binary decision subdiagram associated with the second boolean function and a right pointer to a third data structure {b, f(a=1, b=0, . . . ), f(a=1, b=1, . . . )} that makes it possible to access a second binary decision subdiagram associated with the third boolean function. The second and third data structures is the same type as the first data structure with, respectively, a second and third node occupied by a second binary variable b, c. The above operation is repeated until the last binary variable w yields the binary decision diagram T_{f} constituted by a chaining {a, {b, { . . . }, { . . . }}, {b, { . . . }, { . . . }}} of the structures by means of the pointers. An identifier of the binary decision diagram T_{f} points to the first node, called the root node.

The representation in memory of a function by a binary decision diagram offers the appreciable advantage of compactness because if two or more binary decision subdiagrams are identical, only one representation in memory is enough, since two or more pointers can point to the same data structure. When a function is independent of a binary variable, the binary decision diagram is simplified. The representation in memory of a function by a binary decision diagram can be implicit in the sense that it is possible to perform calculations on the root node without necessarily extending the binary decision diagram for all of the nodes.

One advantageous property of binary decision diagrams results from the following statement on the Shannon decomposition. When a boolean function h(a, b, c, . . . , 2) results from a combinational operation Φ(f, g) of one or more boolean functions f(a, b, c, . . . , w), g(a, b, c, . . . , w):

h(a,b,c, . . . , w)=\overline{a}·h(a=0,b,c, . . . , w)+a·h(a=1,b,c, . . . , w)=

\overline{a}·Φ(f(a=0,b,c, . . . , w),g(a=0,b,c, . . . , w))+

a·Φ(f(a=1,b,c, . . . , w),g(a=1,b,c, . . . ,w))=

Φ(\overline{a}·f(a=0,b,c, . . . ,w),\overline{a}·g(a=0,b,c, . . . ,w))+Φ(a·f(a=1,b,c, . . . , w),a·g(a=1,b,c, . . . ,w))=

Φ(\overline{a}·f(a=0,b,c, . . . ,w)+a·f(a=1,b,c, . . . ,w),\overline{a}·g(a=0,b,c, . . . ,w))+a·g(a=1,b,c, . . . ,w))

For example, when Φ is a logical complement,

h(a,b,c, w)=\overline{f}(a,b,c, w)

\overline{f}(a,b,c, w)=\overline{·f(a=0,b,c, . . . ,w)+}

a·f(a=1,b,c, w)=

[\overline{·f(a=0,b,c, w)}]·

[\overline{a·f(a=1,b,c, w)}]=

[a+\overline{f(a=0,b,c, w)}]·[\overline{a}+\overline{f(a=1,b,c, w)}]=

\overline{a}·\overline{f}(a=0,b,c, w)+a·\overline{f}(a=1,b,c, . . . , w)

The binary decision diagram associated with the logical complement of a function f includes the same node occupied by the variable a as the binary decision diagram associated with the function f in which the pointer in the binary decision subdiagram associated with the function f for a equal to zero is replaced by a pointer in a binary decision subdiagram associated with the logical complement of the function f for a equal to zero, and in which the pointer in the binary decision subdiagram associated with the function f for a equal to one is replaced by a pointer in a binary decision subdiagram associated with the logical complement of the function f for a equal to one.

When Φ is a logical disjunction of two functions f and g,

h(a,b,c, w)=f(a,b,c, w)+g(a,b,c, w)=\overline{a}·[f(a=0,b,c, w)+g(a=0,b,c, w)]+a·[f(a=1,b,c, w)+g(a=1,b,c, w)]

The binary decision diagram associated with the logical disjunction of two functions f and g includes the same node occupied by the variable a as the binary decision diagram associated with the function f in which the pointer in the binary decision subdiagram associated with the function f for a equal to zero is replaced by a pointer in a binary decision subdiagram associated with the logical disjunction of the function f for a equal to zero and the function g for a equal to zero, and in which the pointer in the binary decision subdiagram associated with the function f for a equal to one is replaced by a pointer in a binary decision subdiagram associated with the logical disjunction of the function f for a equal to one and the function g for a equal to one.

When Φ is a logical conjunction of two functions f and g,

h(a,b,c, . . . ,w)=f(a,b,c, . . . ,w)·g(a,b,c, . . . ,w)=\overline{a}·[f(a=0,b,c, . . . ,w)·g(a=0,b,c, . . . ,w)]+a·[f(a=1,b,c, . . . ,w)·g(a=1,b,c, . . . ,w)]

The binary decision diagram associated with the logical conjunction of two functions f and g includes the same node occupied by the variable a as the binary decision diagram associated with the function f in which the pointer in the binary decision subdiagram associated with the function f for a equal to zero is replaced by a pointer in a binary decision subdiagram associated with the logical conjunction of the function f for a equal to zero and the function g for a equal to zero, and in which the pointer in the binary decision subdiagram associated with the function f for a equal to one is replaced by a pointer in a binary decision subdiagram associated with the logical conjunction of the function f for a equal to one and the function g for a equal to one.

By proceeding recursively up to the last variable w of one or more functions f, g, it is possible to perform, in a simple way, any combinational operation Φ of one or more binary decision diagrams.

However, the problem is that the binary decision diagrams are known to apply to variables or logical propositions that are purely binary, i.e., true or false. In the case of circuit tests, a signal can have more than two states, for example a high or low logical state but also a high-impedance state, on output from a transistor set in a blocked state or even in an indeterminate state in a junction node of several traces conveying states of different signals. The invention eliminates this drawback.

The subject of the invention is a method for encoding more than two possible states of a signal, characterized in that it comprises:

a first step that associates with the signal a first binary variable, a first value of which indicates that the signal is in a first state or in a second state, a second binary variable, a first value of which indicates that the signal is in the first state or in a third state, a first binary decision diagram, and a second binary decision diagram; and

a second step that constructs the first binary decision diagram using a first rule causing the first binary decision diagram to lead to a first value when the first binary variable is at its first value, and that constructs the second binary decision diagram using a second rule causing the second binary decision diagram to lead to the first value when the second binary variable is at its first value.

Thus, a logical conjunction of the first binary decision diagram and the second binary decision diagram that leads to the first value encodes the first state of the signal. A logical conjunction of the first binary decision diagram and the complement of the second binary decision diagram that leads to the first value encodes the second state of the signal. A logical conjunction of the complement of the first binary decision diagram and of the second binary decision diagram that leads to the first value encodes the third state of the signal.

The corollary subjects of the invention are a data processing system, such as a computer, a computer program, and a recording medium such as a magnetic disk or a CD-ROM that make it possible to implement the method of the invention.

Other advantages and details of the invention emerge from the following description of the preferred exemplary embodiment, given in reference to the following figures:

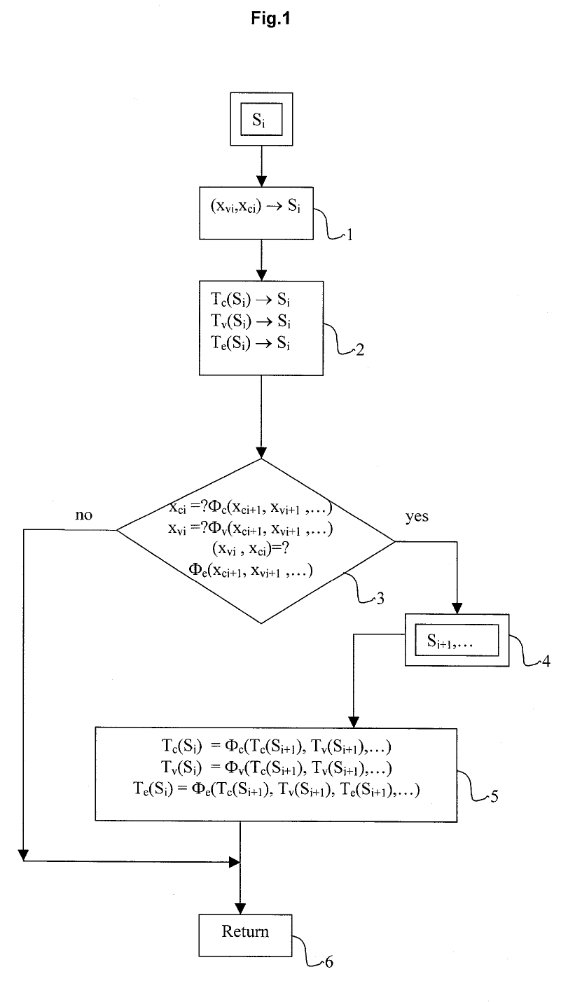

FIG. 1 describes the steps of the method according to the invention;

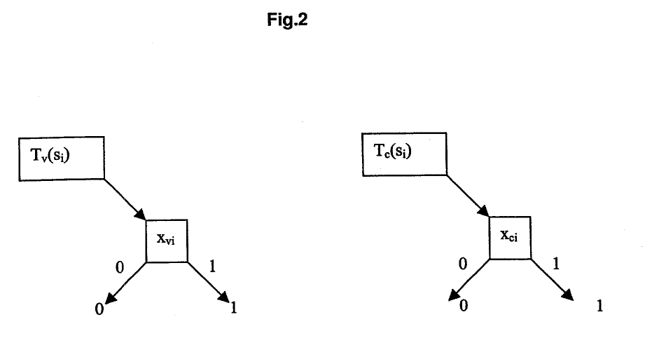

FIG. 2 represents two elementary binary decision diagrams according to the invention;

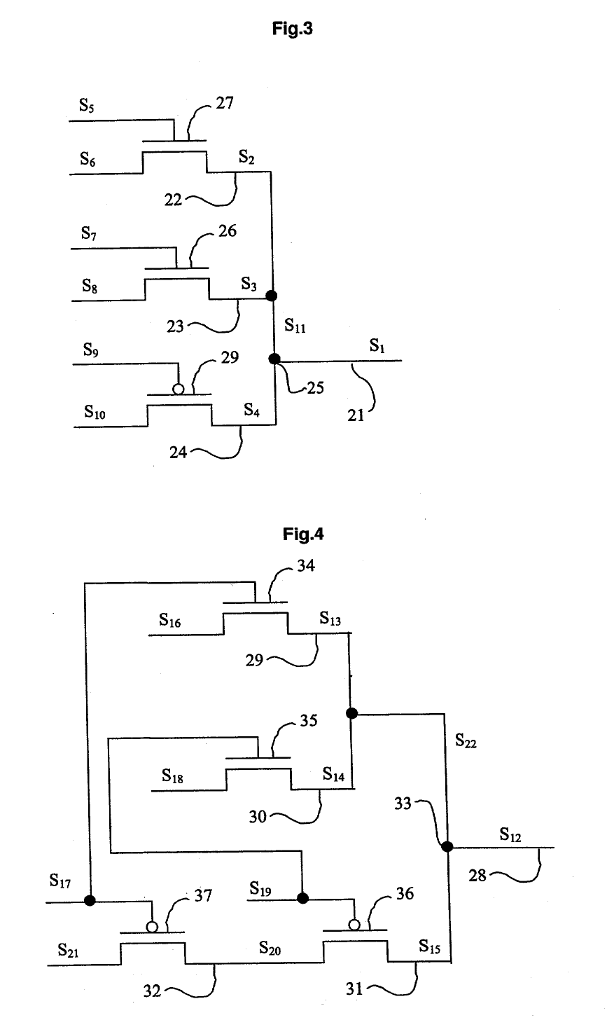

FIG. 3 represents a first exemplary elementary circuit to which the invention is to be applied;

FIG. 4 represents a second exemplary elementary circuit to which the invention is to be applied; and

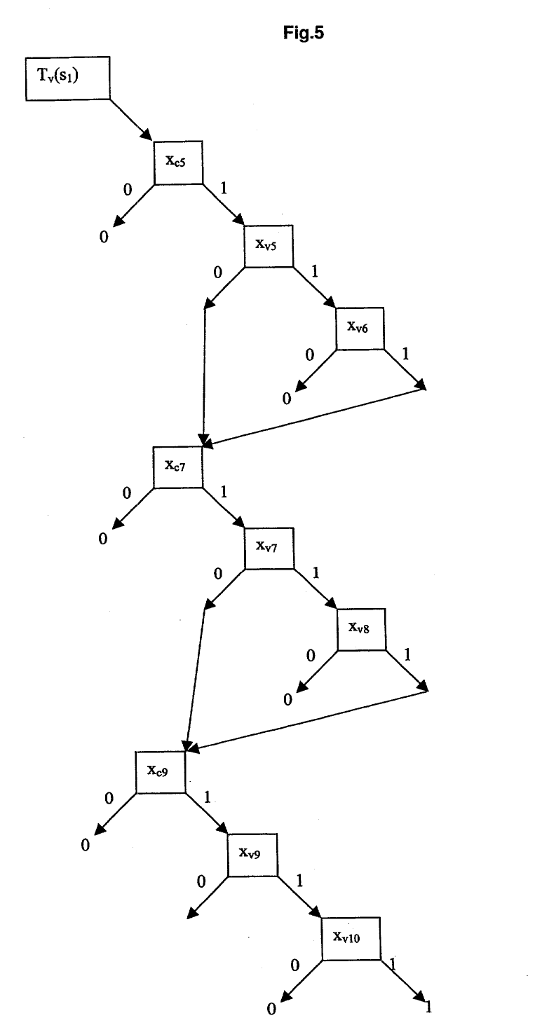

FIG. 5 represents a binary decision diagram according to the invention for a signal resulting from the state of other signals.

FIG. 1 describes the steps of the method applied by computer to a netlist of an analyzed circuit from which a signal sᵢ is extracted.

In a first step 1, a pair of binary variables (xᵥᵢ, x_{ci}) is assigned to a signal Sᵢ in order to encode at least three possible states of the signal Sᵢ. The variable x_{ci}, called a context variable, is defined so as to indicate that, when its value is equal to 1, the values 0 and 1 of the variable xᵥᵢ, respectively, directly encode logical states B and H of the signal Sᵢ. When the value of the context variable x_{ci} is equal to 0, the values 0 and 1 of the variable xᵥᵢ respectively encode an indeterminate state and a state Z of the signal Sᵢ. The state Z of the signal Sᵢ is a high-impedance state in the sense in which the term is usually understood in an electric circuit. In the indeterminate state, there is an error state E of the signal Sᵢ such as, for example, an electrical short circuit. The pair of binary variables (xᵥᵢ, x_{ci}) thus makes it possible to encode four possible states of the signal Sᵢ.

In a second step 2, three binary decision diagrams Tₓ(Sᵢ), T_{c}(Sᵢ), Tₑ(Sᵢ) are assigned to the signal Sᵢ.

The so-called value binary decision diagram Tᵥ(Sᵢ) is constructed so that it leads to 1 if the state of the signal Sᵢ is the high-impedance state Z or the logical state H.

The so-called context binary decision diagram T_{c}(Sᵢ) is constructed so that it leads to 1 if the state of the signal Sᵢ is the logical state B or the logical state H.

The so-called error binary decision diagram Tₑ(Sᵢ) is constructed so that it leads to 1 if the state of the signal Sᵢ is an error state.

In a step 3, the computer searches in the netlist to see if there is an element generating the signal Sᵢ from one or more signals Sᵢ₊₁, Sᵢ₊₂.

When the signal Sᵢ does not depend on any other signal, each of the variables xᵥᵢ, x_{ci} of the pair of variables (xᵥᵢ, x_{ci}) can assume a value equal to 0 or 1. This is the case, for example, for an input signal of the electric circuit or for an intermediate signal that it is possible to force by means of a test probe. The binary decision diagrams Tᵥ(Sᵢ), T_{c}(Sᵢ) are represented in FIG. 2., where Tᵥ(Sᵢ) leads to 1 if xᵥᵢ is equal to 1, T_{c}(Sᵢ) leads to 1 if x_{ci} is equal to 1. There is no reason for Tₑ(Sᵢ) to exist, since it would be prejudicial to apply an error to an input of a circuit to be tested. The method then goes directly from step 3 to a return step 6, which makes the binary decision diagrams available in memory in the computer.

When the signal Sᵢ depends on at least one signal Sᵢ₊₁, Sᵢ₊₂, the computer searches in a rule library for one or more rules producing a behavior of the signal Sᵢ as a function of the signal or signals Sᵢ₊₁, Sᵢ₊₂ for the element in the netlist that generates the signal Sᵢ.

In a step 4, the binary decision diagrams Tᵥ(Sᵢ₊₁), T_{c}(Sᵢ₊₁), Tₑ(Sᵢ₊₁) for each signal Sᵢ₊₁ are searched for in memory in the computer. If these binary decision diagrams do not already exist, steps 1 through 6 are executed recursively for each of the signals Sᵢ₊₁.

In a step 5, by applying rules found in step 3:

the binary decision diagram Tᵥ(Sᵢ) is constructed by means of the combination Φᵥ, which yields Tᵥ(Sᵢ) as a function of the binary decision diagrams Tᵥ(Sᵢ₊₁), T_{c}(Sᵢ₊₁), Tₑ(Sᵢ₊₁), Tᵥ(Sᵢ₊₂), T_{c}(Sᵢ₊₂), Tₑ(Sᵢ₊₂);

the binary decision diagram T_{c}(Sᵢ) is constructed by means of a combination Φ_{c}, which yields Tᵥ(Sᵢ) as a function of the binary decision diagrams Tᵥ(Sᵢ₊₁), T_{c}(Sᵢ₊₁), Tₑ(Sᵢ₊₁), Tᵥ(Sᵢ₊₂), T_{c}(Sᵢ₊₂), Tₑ(Sᵢ₊₂);

the binary decision diagram Tₑ(Sᵢ) is constructed by means of a combination Φₑ, which yields Tᵥ(Sᵢ) as a function of the binary decision diagrams Tᵥ(Sᵢ₊₁), T_{c}(Sᵢ₊₁), Tₑ(Sᵢ₊₁), Tᵥ(Sᵢ₊₂), T_{c}(Sᵢ₊₂), Tₑ(Sᵢ₊₂).

The known precepts for combining binary decision diagrams are applied.

Let's apply, for example, the method described above to the elementary circuit of FIG. 3, which constitutes a multiplexer with three inputs.

A conductor 21 conveys a signal S₁. The conductor 21 is connected at a point 25 to three conductors 22, 23, 24 in parallel. The conductors 22, 23, 24 each convey a signal, respectively S₂, S₃, S₄. The coupling of the signals S₂, S₃ at the point 25 is equivalent to an intermediate signal S₁₁ coupled at the point 25 with the signal S₄.

The variable xᵥ₁ is equal to 1 if and only if the state of each of the signals S₁, S₂, S₃ is the high-impedance state Z or the logical state H.

The applicable rule Rᵥ for constructing the binary decision diagram Tᵥ(S₁₁) is a rule Rᵥᵣ for two conductors coupled at the same point 25: Tᵥ(S₁₁)=Tᵥ(S₂)·Tᵥ(S₃).

Tᵥ(S₁₁) now being present in memory, the rule Rᵥᵣ is again applied to S₁₁ and S₄.

Tᵥ(S₁)=Tᵥ(S₁₁)·Tᵥ(S₄).

An error occurs in the signal S₁₁ if one of the signals S₂, S₃ is in the logical state H while the other signal S₃, S₂ is in the logical state B, or if one of the signals S₂, S₃ is in the error state. The applicable rule Rᵥ for constructing the binary decision diagram Tₑ(S₁₁) is a rule Rₑᵣ for two conductors coupled at the point 25:

Te(s11)=Tc(s2)·Tc(s3)·└Tv(s2)·\overline{Tv(s3)}+\overline{Tv(s2)}·Tv(s3)┘+Te(s2)+Te(s3)

An error occurs in the signal S₁ if one of the signals S₁₁, S₄ is in the logical state H while the other signal S₄, S₁₁ is in the logical state B, or if one of the signals S₁₁, S₄ is in the error state. The rule Rₑᵣ is again applicable for constructing the binary decision diagram Tₑ(S₁).

Te(s1)=Tc(s11)·Tc(s4)·└Tv(s11)·\overline{Tv(s4)}+\overline{Tv(s11)}·Tv(s4)┘+Te(s11)+Te(s4)

The variable xc₁ is equal to 1 if the state of the signal S₁ is the logical state B or the logical state H. The signal S₁₁ is in the state B or H if and only if the signal S₂ or the signal S₃ is in the logical state B or H and if no error results from the signals S₂ and S₃ in the signal S₁₁. The applicable rule R_{c} for constructing the binary decision diagram T_{c}(S₁₁) is a rule R_{cr} for two conductors coupled at the point 25: Tc(s11)=[Tc(s2)+Tc(s3)]·└\overline{Tc(s2)·Tc(s3)·[Tv(s2)·+·Tv(s3)}]┘Tc(s11)=[Tc(s2)+Tc(s3)]·└\overline{Tc(s2)}+\overline{Tc(s3)}+└\overline{Tv(s2)}+Tv(s3)┘·└Tv(s2)+\overline{Tv(s3)}┘┘Tc(s11)=+Tc(s2)·[\overline{Tc(s3)}+\overline{Tv(s2)}·\overline{Tv(s3)}+Tv(s2)·Tv(s3)]+Tc(s3)·[\overline{Tc(s2)}+\overline{Tv(s2)}·\overline{Tv(s3)}+Tv(s2)·Tv(s3)]

The rule R_{cr} is again applied for the signals S₁₁ and S₄: Tc(s1)=+Tc(s11)·[\overline{Tc(s4)}+\overline{Tv(s11)}·\overline{Tv(s4)}+Tv(s11)·Tv(s4)]+Tc(s4)·[\overline{Tc(s11)}+\overline{Tv(s11)}·\overline{Tv(s4)}+Tv(s11)·Tv(s4)]

If for S₂, Tᵥ(S₂), T_{c}(S₂), Tₑ(S₂) are not present in memory, the second step is repeated for the signal S₂.

The conductor 22 is coupled to the drain of an N-type MOS transistor 27. The grid of the transistor 27 receives a signal S₅ and the source of the transistor 27 receives a signal S₆. In CMOS technology, the concept of a drain, and of a source, of a transistor is tied in a known way to its operating state; these two concepts are also interchangeable.

The signal S₂ is in the logical state H if and only if the signals S₅ and S₆ are in the logical state H. The signal S₂ is in the high-impedance state Z if and only if the signal S₅ is in the logical state B or if the signal S₅ is in the logical state H and the signal S₆ is in the high-impedance state Z. The rule Rᵥ that is applied is a rule Rᵥₙ:

Tv(s2)=[Tc(s5)·Tv(s5)·Tc(s6)·Tv(s6)+Tc(s5)·\overline{Tv(s5)}]+Tc(s5)·Tv(s5)·\overline{Tc(s6)}·Tv(s6)

which with simplification yields:

Tv(s2)=[Tc(s5)·Tv(s5)·Tv(s6)+Tc(s5)·\overline{Tv(s5)}]

The signal S₂ is in the error state E if the signal S₅ is in the high-impedance state Z. In fact, a transistor grid hit by a high-impedance signal is particularly noise-sensitive. The rule Rₑ that is applied is a rule Rₑₙ:

Te(s2)=Tv(s5)·\overline{Tc(s5)}

The signal S₂ is in the logical state B or H if and only if the signal S₅ is in the logical state H and the signal S₆ is in the logical state B or H. The rule R_{c} that is applied is a rule R_{cn}:

Tc(s2)=Tc(s5)·Tv(s5)·Tc(s6)

If for S₄, Tᵥ(S₄), T_{c}(S₄), Tₑ(S₄) are not present in memory, the second step is repeated for the signal S₄.

The conductor 23 is coupled to the drain of an N-type MOS transistor 26. The grid of the transistor 26 receives a signal S₇ and the source of the transistor 26 receives a signal S₈.

The first two steps are executed for the signal S₃ using the same rules Rᵥₙ, R_{cn} and Rₑₙ as for the signal S₂ so as to obtain:

Tv(s3)=[Tc(s7)·Tv(s7)·Tv(s8)+Tc(s7)·\overline{Tv(s7)}]Te(s3)=Tv(s7)·\overline{Tc(s7)}Tc(s3)=Tc(s7)·Tv(s7)·Tc(s8)

The conductor 24 is coupled to the drain of a P-type MOS transistor 29. The grid of the transistor 29 receives a signal S₉ and the source of the transistor 27 receives a signal S₁₀.

The signal S₄ is in the logical state H if and only if the signals S₉ and S₁₀ are respectively in the logical state B and H. The signal S₄ is in the high-impedance state Z if and only if the signal S₉ is in the logical state H or if the signal S₉ is in the logical state B and the signal S₁₀ is in the high-impedance state Z. After simplification, the rule Rᵥ that is applied is a rule Rᵥₚ:

Tv(s4)=[Tc(s9)·\overline{Tv(s9)}·Tv(s10)+Tc(s9)·Tv(s9)]

The signal S₄ is in the error state E if the signal S₉ is in the high-impedance state Z. In fact, a transistor grid hit by a high-impedance signal is particularly noise-sensitive. The rule Rₑ that is applied is a rule Rₑₚ:

Te(s4)=Tv(s9)·\overline{Tc(s9)}

The signal S₄ is in the logical state B or H if and only if the signal S₉ is in the logical state B and the signal S₁₀ is in the logical state B or H. The rule R_{c} that is applied is a rule R_{cp}:

Tc(s4)=Tc(s9)·\overline{Tv(s9)}·Tc(s10)

Thus, the binary decision diagrams Tᵥ(S₁), T_{c}(S₁), Tₑ(S₁) are obtained as a function of the binary decision diagrams Tᵥ(S₅), T_{c}(S₅), Tᵥ(S₆), T_{c}(S₆), Tᵥ(S₇), T_{c}(S₇), Tᵥ(S₈), T_{c}(S₈), Tᵥ(S₉), T_{c}(S₉), Tᵥ(S₁₀), T_{c}(s₁₀).

FIG. 5 shows, for example, the binary decision diagram Tᵥ(S₁) obtained by successively replacing each of the binary decision diagrams in the formulas given above for Tᵥ(S₁) by the binary decision diagrams Tᵥ(Sᵢ), T_{c}(Sᵢ), for S equal to S₅, S₆, S₇, S₈, S₀, S₁₀.

If one is interested in the possible states of the signal S₁, for two possible logical states B and H of each of the signals S₅ through S₁₀, the third step is executed, wherein each of the binary decision diagrams T_{c}(S₅), T_{c}(S₆), T_{c}(S₇), T_{c}(S₈), T_{c}(S₉), T_{c}(S₁₀) equals 1 and wherein each of the binary decision diagrams Tᵥ(S₅), Tᵥ(S₆), Tᵥ(S₇), Tᵥ(S₈), Tᵥ(S₉), Tᵥ(S₁₀) is replaced, respectively, by each of the binary decision diagrams {xᵥ₅;0;1}, {xᵥ₆;0;1}, {xᵥ₇;0;1}, {xᵥ₈;0;1}, {xᵥ₉;0;1}, {xᵥ₁₀;0;1}. Thus, three binary decision diagrams Tᵥ(S₁), T_{c}(S₁), Tₑ(S₁) are obtained with nodes occupied by the variables xᵥ₅, xᵥ₆, xᵥ₇, xᵥ₈, xᵥ₉, xᵥ₁₀ and with leaves at 0 or at 1.

In order to know, for example, which values of xᵥ₅, xᵥ₆, xᵥ₇, xᵥ₈, xᵥ₉, xᵥ₁₀ set the signal S₁ at the logical state 1, the fourth step constructs a binary decision diagram T₁(S₁) using the rule R₁:

T1(s1)=Tv(s1)·Tc(s1)·\overline{Te(s1)}

The binary decision diagram T₁(S₁) is scanned through each branch leading from the node occupied by the variable xᵥ₅, to a leaf occupied by the value 1, saving in a logical conjunction each variable xᵥ₅, xᵥ₆, xᵥ₇, xᵥ₈, xᵥ₉, xᵥ₁₀ encountered, as is if the scanning of the branch is done by means of the right pointer and complemented if the scanning of the branch is done by means of the left pointer. Each logical conjunction obtained by the scan through a branch is saved in a logical disjunction until all of the branches leading to a leaf occupied by the value 1 have been scanned. Thus, the logical equation of the circuit of FIG. 3 is obtained:

s1=+s5·s6·s7·s8·\overline{s}9·s10+s5·s6·s7·s8·s9+s5·s6·\overline{s}9·\overline{s}8·s10+\overline{s}5·s7·s8·s9+\overline{s}5·s7·s8 ·\overline{s}9·s10+\overline{s}5·\overline{s}7·\overline{s}9s10+s5.s6s7 \overline{s}9

Let's apply, for example, the method described above to the elementary circuit of FIG. 4, wherein five input signals s₁₆, s₁₇, s₁₈, s₁₉, s₂₁ are combined so as to generate a signal s₁₂.

The elementary circuit entity of FIG. 4 comprises two NMOS transistors 34 and 35, whose sources are respectively hit by the signals S₁₆ and S₁₈, whose grids are respectively hit by the signals S₁₇ and S₁₉, and whose drains respectively generate signals S₁₃ and S₁₄ in conductors 29 and 30. The elementary circuit entity of FIG. 4 also comprises two PMOS transistors 37 and 36, whose sources are respectively hit by the signal S₂₁ and a signal S₂₀, whose grids are respectively hit by the signals S₁₇ and S₁₉, and whose drains respectively generate the signal S₂₀ and a signal S₁₅ in conductors 32 and 31. The conductors 29, 30 and 31 are connected to a conductor 28 at a point 33.

The fifth step scans each of the signals S₁₆, S₁₇, S₁₈, S₁₉, S₂₁ of the netlist and for each signal scanned, executes the first two steps.

In the case where the sources of the transistors 34 and 35 are connected to the ground, the binary decision diagrams Tᵥ(S₁₆), T_{c}(S₁₆), Tₑ(S₁₆), Tᵥ(S₁₈), T_{c}(S₁₈), Tₑ(S₁₈) are respectively equal to the singletons {0}, {1}, {0}, {0}, {1}, {0}. In the case whe source of the transistor 37 is connected to the supply, the binary decision diagrams Tᵥ(S₂₁), T_{c}(S₂₁), Tₑ(S₂₁) are respectively equal to the singletons {1}, {1}, {0}. In the case where the grids of the transistors 34 and 37 are connected to an input, necessarily set to a logical state B or H, the binary decision diagrams Tᵥ(S₁₇), T_{c}(S₁₇), Tₑ(S₁₇) are respectively {xᵥ₁₇,0,1}, {1}, {0}. In the case where the grids of the transistors 35 and 36 are connected to an input, necessarily set to a logical state B or H, the binary decision diagrams Tᵥ(S₁₉), T_{c}(S₁₉), Tₑ(S₁₉) are respectively {xᵥ₁₉,0,1}, {1}, {0}.

The sixth step then scans the elements of the elementary circuit attacked by the signals S₁₆, S₁₇, S₁₈, S₁₉, S₂₁ of the netlist and associates with the transistors 34, 35, 37, respectively, the signals S₁₃, S₁₄, S₂₀, for each of which it executes the first two steps.

For the transistor 34, the rules Rᵥₙ, R_{cn}, Rₑₙ are applied to the signal S₁₃, in the second step.

Tv(s13)=[Tc(s17)·Tv(s17)·Tv(s16)+Tc(s17)·\overline{Tv(s17)}]

Tc(s13)=Tc(s17)·Tv(s17)·Tc(s16)

Te(i s13)=Tv(s17)·\overline{Tc(s17)}

Which yields, when applying the known rules for combining binary decision diagrams:

Tᵥ(S₁₃)={xᵥ₁₇,1,0}

T_{c}(S₁₃)={xᵥ₁₇,0,1}

Tₑ(S₁₃)={0}

For the transistor 35, the rules Rᵥₙ, R_{cn} Rₑₙ are applied to the signal S₁₄, in the second step, so as to yield, in identical fashion:

Tᵥ(S₁₄)={xᵥ₁₉,1,0}

T_{c}(S₁₄)={xᵥ₁₉,0,1}

Tₑ(S₁₄)={0}

For the transistor 37, the rules Rᵥₚ, R_{cp} Rₑₚ are applied to the signal S₂₀, in the second step.

Tv(s20)=[Tc(s17)·\overline{Tv(s17)}·Tv(s21)+Tc(s17)·Tv(s17)]

Tc(s20)=Tc(s17)·\overline{Tv(s17)}·Tc(s21)

Te(s20)=Tv(s17)·\overline{Tc(s17)}

Which yields, when applying the known rules for combining binary decision diagrams:

Tᵥ(S₂₀)={1}

T_{c}(S₂₀)={xᵥ₁₇,1,0}

Tₑ(S₂₀)={0}

The sixth step is re-activated in order to scan the elements of the elementary circuit hit by the previously generated signals S₁₃, S₁₄, S₂₀ of the net list, and associates with these elements, which are the point 33 and the transistor 36, respectively the signals S₂₂ and S₁₅, for each of which it executes the first two steps.

For the point 33, the rules Rᵥᵣ, R_{cr} Rₑₙ are applied to the signal S₂₂, in the second step.

Tv(S₂₂)=Tv(S₁₃)·Tv(S₁₄)Tc(s22)=+Tc(s13)·[\overline{Tc(s14)}+\overline{Tv(s13)}·\overline{Tv(s14)}+Tv(s13)·Tv(s14)]+Tc(s14)·[\overline{Tc(s13)}+\overline{Tv(s13)}·\overline{Tv(s14)}+Tv(s13)·Tv(s14)]Te(s22)=Tc(s13)·Tc(s14)·└Tv(s13)·\overline{Tv(s14)}+\overline{Tv(s13)}·Tv(s14)┘

Which yields, when applying the known rules for combining binary decision diagrams:

Tᵥ(S₂₂)={xᵥ₁₇,{xᵥ₁₉,1,0},0}

T_{c}(S₂₂)={xᵥ₁₇,{xᵥ₁₉,0,1},1}

Tₑ(S₂₂)={xᵥ₁₇, 0,{xᵥ₁₉,0,0}}={0}

For the transistor 36, the rules Rᵥₚ, R_{cp} Rₑₚ are applied to the signal S₁₅, in the second step.

Tv(s15)=[Tc(s19)·\overline{Tv(s19)}·Tv(s20)+Tc(s19)·Tv(s19)]

Tc(s15)=Tc(s19)·\overline{Tv(s19)}·Tc(s20)

Te(s15)=Tv(s19)·\overline{Tc(s19)}

Which yields, when applying the known rules for combining binary decision diagrams:

Tᵥ(S₁₅)={1}

T_{c}(S₁₅)={xv₁₇,{xᵥ₁₉,1,0},0}

Tₑ(S₁₅)={0}

The sixth step is re-activated in order to scan the elements of the elementary circuit hit by the previously generated signals S₂₂, S₁₅ of the netlist and associates with the only element found, which is the point 33, the signal S₁₂, for which it executes the first two steps.

For the point 33, the rules Rᵥᵣ, R_{cr}, Rₑᵣ are applied to the signal S₁₂, in the second step.

Tv(S₁₂)=Tv(S₂₂)·Tv(S₁₅)Tc(s12)=+Tc(s22)·[\overline{Tc(s15)}+\overline{Tv(s22)}·\overline{Tv(s15)}+Tv(s22)·Tv(s15)]+Tc(s15)·[\overline{Tc(s22)}+\overline{Tv(s22)}·\overline{Tv(s15)}+Tv(s22)·Tv(s15)]Te(s12)=Tc(s22)·Tc(s15)·└Tv(s22)·\overline{Tv(s15)}+\overline{Tv(s22)}·Tv(s15)┘

Which yields, when applying the known rules for combining binary decision diagrams:

Tᵥ(S₁₂)={xᵥ₁₇,{xᵥ₁₉,1,0},0}

T_{c}(S₁₂)={xᵥ₁₇,1,{xᵥ₁₉,1,1}}={1}

Tₑ(S₁₂)={xᵥ₁₇,0,{xᵥ₁₉,0,0}}={0}

The only remaining signal being the signal S₁₂, the fourth step yields the binary decision diagram T_{log}(S12) using the rule R_{log}:

$$\begin{matrix}{T}_{log} ( {S}_{12} ) = {T}_{v} ( {S}_{12} ) \cdot {T}_{c} ( {S}_{12} ) \\ = \{ {x}_{v17} , \{ {x}_{v19} , 1 , 0 \} , 0 \}\end{matrix}$$

The binary variable xᵥ₁₂ is at the logical state 1 for the branches of the binary decision diagram T_{log}(S₁₂) that lead to 1. This is written:

xv12=\overline{xv}17·\overline{xv}19

In the fourth step, the circuit of FIG. 4 is recognized as being a NOR gate.

In the exemplary embodiment of the invention, a first binary decision diagram leads to 1 when the state of the signal with which it is associated is a high-impedance state Z or a logical state H, a second binary decision leads to 1 when the state of the signal with which it is associated is a logical state B or a logical state H, and a third binary decision diagram leads to 1 when the state of the signal with which it is associated is an error state E.

One skilled in the art can easily draw on the teaching of the invention by defining the three binary decision diagrams differently; for example, the first binary decision diagram leads to 1 when the state of the signal with which it is associated is a high-impedance state Z or a logical state H, the second binary decision diagram leads to 1 when the state of the signal with which it is associated is a high-impedance state Z or a logical state B, and the third binary decision diagram leads to 1 when the state of the signal with which it is associated is an error state E. Depending on the needs he deems most appropriate to a particular application, one skilled in the art can define other binary decision diagrams in order for each to positively encode a presence of one or two possible states among several, and negatively encode an absence of this or these two possible states.

Choosing the mode of implementation in the preceding description offers an interesting advantage in rapidly recognizing a logical state of a signal, a priori binary. In fact, when the second binary decision diagram T_{c}(Sᵢ) leads to 1, the state of the signal is either the logical state B or H, and hence neither the state Z nor the state E. Since the first binary decision diagram Tᵥ(Sᵢ) leads to 1 if the state of the signal is the state Z or the state H, the first binary decision diagram Tᵥ(Sᵢ) therefore leads to 1 if the state of the signal is the state H. Since the first binary decision diagram Tᵥ(Sᵢ) leads to 0 if the state of the signal is not the state H, the first binary decision diagram Tᵥ(Sᵢ) therefore leads to 0 if the state of the signal is the state B. Thus, it is noted that when the so-called context binary decision diagram T_{c}(Sᵢ) leads to 1, the fact of leading to 1 for the so-called value binary decision diagram Tᵥ(Sᵢ) indicates a logical state H of the signal Sᵢ, and the fact of leading to 0 indicates a logical state B of the signal Sᵢ.

1. Method for encoding more than two possible states (H, B, Z) of a first signal (Sᵢ), characterized in that it comprises:
a first step that associates with the first signal (Sᵢ) a first binary variable (x_{ci}), a first value (1) of which indicates that the first signal (Sᵢ) is in a first state (H) or in a second state (B), a second binary variable (xᵥᵢ), a first value (1) of which indicates that the first signal (Sᵢ) is in the first state (H) or in a third state (Z), a first binary decision diagram (T_{c}(Sᵢ)), and a second binary decision diagram (Tᵥ(Sᵢ)); and
a second step that constructs the first binary decision diagram (T_{c}(Sᵢ)) using a first rule (Rc) causing the first binary decision diagram (T_{c}(Sᵢ)) to lead to a first value (1) when the first binary variable (x_{ci}) is at its first value (1), and that constructs the second binary decision diagram (Tᵥ(Sᵢ)) using a second rule (Rv) causing the second binary decision diagram (Tᵥ(Sᵢ)) to lead to the first value (1) when the second binary variable (xᵥᵢ) is at its first value (1).

2. Method according to claim 1, characterized in that, the first signal (Sᵢ) being generated by an elementary entity receiving as input one or more second signals (Sᵢ₊₁, Sᵢ₊₂) to which the first and second steps are applied, a first combinational operation (Φ_{c}) and a second combinational operation (Φᵥ) are associated with this entity, the first combinational operation (Φ_{c}) yielding the value of the first binary variable (x_{ci}) associated with the first signal (Sᵢ), as a function of the value of the first or each of the first binary variable(s) (x_{ci+1}, x_{ci+2}) respectively associated with the second signal or signals (Sᵢ₊₁, Sᵢ₊₂), and as a function of the value of the second or each of the second binary variable(s) (xᵥᵢ₊₁, xᵥᵢ₊₂) respectively associated with the second signal or signals (Sᵢ₊₁, Sᵢ₊₂), the second combinational operation (Φᵥ) yielding the value of the second binary variable (xᵥᵢ) associated with the first signal (Sᵢ), as a function of the value of the first or each of the first binary variables (x_{ci+1}, x_{ci+2}) respectively associated with the second signals (Sᵢ₊₁, Sᵢ₊₂) and as a function of the value of the second or each of the second binary variables (xᵥᵢ₊₁, xᵥᵢ₊₂) respectively associated with the second signal or signal(s) (Sᵢ₊₁, Sᵢ₊₂).

3. Method according to claim 2, characterized in that the first rule (Rc) constructs the first binary decision diagram (T_{c}(Sᵢ)), associated with the first signal (Sᵢ), by replacing in the first combinational operation (Φ_{c}) each of the first binary variables (x_{ci+1}, x_{ci+2}) associated with the second signals (Sᵢ₊₁, Sᵢ₊₂) by each of the first binary decision diagrams (T_{c}(Sᵢ₊₁), T_{c}(Sᵢ₊₂)) associated with the second signals (Sᵢ₊₁, Sᵢ₊₂) and each of the second binary variables (xᵥᵢ₊₁, xᵥᵢ₊₂) associated with the second signals (Sᵢ₊₁, Sᵢ₊₂) by each of the second binary decision diagrams (Tᵥ(Sᵢ₊₁), Tᵥ(Sᵢ₊₂)) associated with the second signals (Sᵢ₊₁, Sᵢ₊₂).

4. Method according to claim 2 or 3, characterized in that the second rule (Rv) constructs the second binary decision diagram (Tᵥ(Sᵢ)), associated with the first signal (Sᵢ), by replacing in the second combinational operation (Φᵥ)) each of the first binary variables (x_{ci+1}, x_{ci+2}) associated with the second signals (Sᵢ₊₁, Sᵢ₊₂) by each of the first binary decision diagrams (T_{c}(Sᵢ₊₁), T_{c}(Sᵢ₊₂)) associated with the second signals (Sᵢ₊₁, Sᵢ₊₂) and each of the second binary variables (xᵥᵢ₊₁, xᵥᵢ₊₂) associated with the second signals (Sᵢ₊₁, Sᵢ₊₂) by each of the second binary decision diagrams (Tᵥ(Sᵢ₊₁), Tᵥ(Sᵢ₊₂)) associated with the second signals (Sᵢ₊₁, Sᵢ₊₂).

5. Method according to claim 1, characterized in that, the first signal (Sᵢ) not depending on any other signal (Sᵢ), the first rule (Rc) constructs the first binary decision diagram (T_{c}(Sᵢ)), associated with the first signal (Sᵢ), by creating a triplet ({No, Pg, Pd}) comprising a node (No) occupied by the first variable (x_{ci}), a left pointer (Pg) to the second value (0) and a right pointer (Pd) to the second value (1).

6. Method according to claim 1 or 5, characterized in that, the first signal (Sᵢ) not depending on any other signal (Sᵢ), the second rule (Rv) constructs the second binary decision diagram (Tᵥ(Sᵢ)), associated with the first signal (Sᵢ), by creating a triplet ({No′, Pg′, Pd′}) comprising a node (No′) occupied by the first variable (xᵥᵢ), a left pointer (Pg′) to the second value (0) and a right pointer (Pd′) to the second value (1).

7. Method according to any of claims 1 through 6, characterized in that:
the first step associates with the first signal (Sᵢ) a third binary decision diagram (Tₑ(Sᵢ)); and
the second step constructs the third binary decision diagram (Tₑ(Sᵢ)) using a third rule (Re) causing the third binary decision diagram (TₑSᵢ)) to lead to the first value (1) when the first binary variable (x_{ci}) is not at its first value (1) and when the second binary variable (xᵥᵢ) is not at its first value (1).

8. Method according to claim 7, characterized in that, the first signal (Sᵢ) being generated by an elementary unit receiving as input one or more second signals (Sᵢ₊₁, Sᵢ₊₂) to which the first and second steps are applied, a third combinational operation (Φₑ) is associated with this entity, the third combinational operation (Φₑ) yielding a second value of the first binary variable (x_{ci}) and a second value of the second binary variable (xᵥᵢ) associated with the first signal (Sᵢ), as a function of the value of the first or each of the first binary variable(s) (x_{ci+1}, x_{ci+2}) respectively associated with the second signal or signals (Sᵢ₊₁, Sᵢ₊₂) and as a function of the value of the second or each of the second binary variable(s) (xᵥᵢ₊₁, xᵥᵢ₊₂) respectively associated with the second signal or signals (Sᵢ₊₁, Sᵢ₊₂).

9. Method according to claim 8, characterized in that the third rule (Re) constructs the third binary decision diagram (Tₑ(Sᵢ)), associated with the first signal (Sᵢ), by replacing in the third combinational operation (Φₑ) each of the first binary variables (x_{ci+1}, x_{ci+2}) associated with the second signals (Sᵢ₊₁, Sᵢ₊₂) by each of the first binary decision diagrams (T_{c}(Sᵢ₊₁), T_{c}(Sᵢ₊₂)) associated with the second signals (Sᵢ₊₁, Sᵢ₊₂) and each of the second binary variables (xᵥᵢ₊₁, xᵥᵢ₊₂) associated with the second signals (Sᵢ₊₁, Sᵢ₊₂) by each of the second binary decision diagrams (Tᵥ(Sᵢ₊₁), Tᵥ(Sᵢ₊₂)) associated with the second signals (Sᵢ₊₁, Sᵢ₊₂).

10. Computer system including at least a processor and a memory, characterized in that the memory contains a program for implementing the method according to any of claims 1 through 9.

11. Computer program comprising program code portions/means/instructions for executing the method according to any of claims 1 through 9 when said program is executed in a computer system.

12. Computer program recording medium, characterized in that it comprises a program readable by a machine of a computer system for controlling the execution of the method according to any of claims 1 through 9.
